(19) United States
(12) Patent Application Publication
(10) Pub. No.: US 2017/0276336 A1
(43) Pub. Date: Sep. 28, 2017

(54) DECORATION LIGHT CABLE WITH IMPROVED TENSILE STRENGTH

(71) Applicant: Chang-Fu TSAI, Taichung (TW)

(72) Inventor: Chang-Fu TSAI, Taichung (TW)

(21) Appl. No.: 15/081,873

(22) Filed: Mar. 26, 2016

(51) Int. Cl. F21V 23/00; H01B 3/44; H01B 1/02; F21S 4/10

(52) U.S. Cl. CPC F21V 23/001; F21S 4/10; H01B 3/44; H01B 1/02; F21W 2121/00

(57) ABSTRACT

Disclosed is a decoration light cable with improved tensile strength, which includes a conductive line, which includes multiple metal filaments twisted together; an insulation layer, which surrounds, encloses, and houses the conductive line in such a way that the conductive line is located at a center of the insulation layer; and one or more reinforcement lines, which are embedded in the insulation layer in such a way that the reinforcement lines are spaced and separated from the conductive line. The decoration light cable is applicable to connections among decoration lights to improve structural strength. In addition, when the insulation layer is cut and trimmed to expose the conductive line, the reinforcement lines are cut off simultaneously so that no reinforcement lines are left at the cut site to cause undesired interference with a subsequent soldering operation applied to the conductive line. This improves the convenience and quality of soldering.

### BACKGROUND OF THE INVENTION

1. Field of the Invention

The present invention relates to an electrical cable or wire, and more particularly to a decoration light cable having an improved tensile strength and applicable to decoration lights such as Christmas lights.

2. The Related Arts

A conventional electrical wire is generally composed of a conductive core and an outer jacket of insulation. Such a known electrical wire generally has a poor tensile strength so that when used in an exposed condition, such as connecting among multiple decoration lights, the known electrical wire may be easily damaged resulting from pulling and stretching, leading to breaking of the conductive core. Consequently, the electrical performance of the electrical wire is affected. Improved electrical wires are available, which includes one or more nylon lines, which comprise multiple strands of nylon threads or yarns, combined with the central conductive core, such as twisting together with the conductive core, in order to improve the tensile strength of the electrical wire. Examples include U.S. Pat. Nos. 9,140,438 and 9,157,588 and Chinese Patent No. CN 202662362. Although such improvement helps increase the tensile strength of an electrical wire or cable, when an end of the electrical wire or cable is cut off or trimmed or tailored otherwise to for example expose the conductive core for soldering or welding, the nylon lines may not be cut simultaneously and are thus left unintentionally. The nylon line, which is left in the cable unintentionally, may get melted due to the heat induced in the soldering or welding operation. This interferes with the soldering or welding operation of the electrical wire, causing inconvenience of the operation, and may affect the quality of soldering or welding. Thus, it is desired to provide an improved electrical wire or cable that takes advantage of nylon lines to improve tensile strength but effectively eliminates the interference caused by the nylon lines in a soldering or welding operation.

### SUMMARY OF THE INVENTION

The primary object of the present invention is to provide a decoration light cable with improved tensile strength, which comprises an improved structure in which one or more nylon reinforcement lines are embedded in an insulation layer of an electrical cable in order to prevent the reinforcement lines from interfering with a soldering or welding operation, making it possible to conduct the soldering or welding operation in a more smooth and easier way so as to enhance quality of soldering or welding and still improve the tensile strength of the electrical cable.

To achieve the above and other objects, the present invention provides a decoration light cable with improved tensile strength, which, in a preferred embodiment, comprises: a conductive line, which comprises a plurality of metal filaments twisted together; an insulation layer, which surrounds, encloses, and houses the conductive line, such that the conductive line is located at a center of the insulation layer; and one or more reinforcement lines, which are embedded in the insulation layer such that the reinforcement lines are spaced and separated from and thus not in contact with the conductive lines by portions of the insulation layer located and interposed between the conductive line and the reinforcement lines.

In the above-described decoration light cable with improved tensile strength, three reinforcement lines are included and embedded in the insulation layer.

In the above-described decoration light cable with improved tensile strength, the reinforcement lines each comprise a plurality of nylon filaments twisted together.

In the above-described decoration light cable with improved tensile strength, the conductive line comprises a first conductive line layer and a second conductive line layer such that the first conductive line layer is set at a central portion circumferentially enclosed by the second conductive line layer that is set along a circumferential portion.

In the above-described decoration light cable with improved tensile strength, the metal filaments are each one of a copper filament, a tin-plated copper filament, and an aluminum filament.

In the above-described decoration light cable with improved tensile strength, the insulation layer is formed of a plastic material comprising one of polyvinyl chloride (PVC), polyethylene (PE), and polypropylene (PP).

The decoration light cable with improved tensile strength according to the present invention provides the following advantages:

(1) Multiple nylon filaments (or strands of nylon filaments) are provided as reinforcement lines and the reinforcement lines are embedded in an insulation layer so that when the insulation layer is cut and trimmed to expose a central conductive line, the portion of the reinforcement lines that is embedded in the portion of the insulation layer that is cut and trimmed can be simultaneously cut off and is not left to cause undesired interference with a soldering operation applied to the conductive line thereby effectively improving the convenience of the soldering operation and the quality of soldering so conducted.

(2) Multiple nylon filaments (or strands of nylon filaments) are provided in a decoration light cable as reinforcement lines to help improve the tensile strength of the decoration light cable.

### BRIEF DESCRIPTION OF THE DRAWINGS

The present invention can be fully understood from the following detailed description and preferred embodiments with reference to the accompanying drawings, in which:

FIG. 1 is a perspective view showing a decoration light cable according to a preferred embodiment of the present invention;

FIG. 2 is a cross-sectional view of the decoration light cable according to the preferred embodiment of the present invention; and

FIG. 3 is a schematic view illustrating an application of the decoration light cable of the present invention to a decoration light device.

### DETAILED DESCRIPTION OF THE PREFERRED EMBODIMENTS

To better expound the purposes, features, and effectiveness of the present invention to help better understand and appreciate the present invention, description will be given below with reference to embodiments and drawings of the present invention.

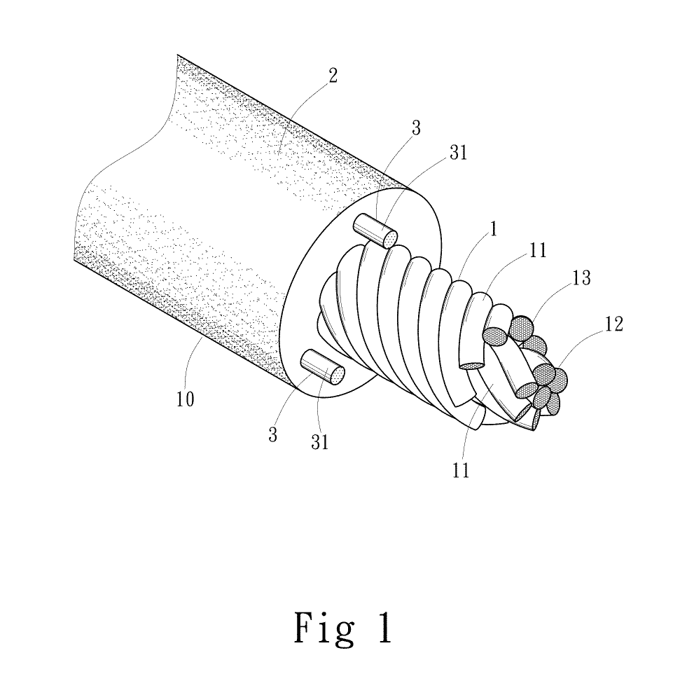

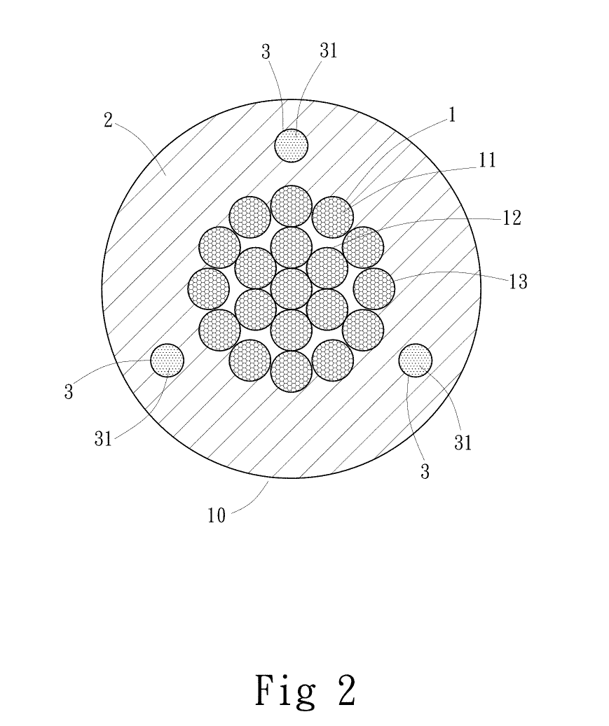

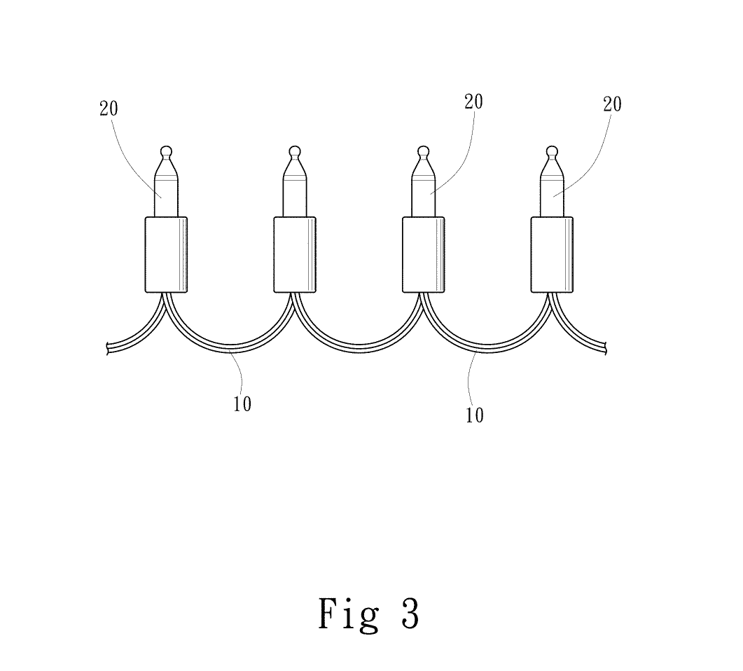

Referring to FIGS. 1 and 2, which are respectively a perspective view and a cross-sectional view showing a decoration light cable with improved tensile strength, generally designated at 10, the decoration light cable of the present invention is applicable to decoration lights 20 (as shown in FIG. 3), and a preferred embodiment of the decoration light cable of the present invention comprises: a conductive line 1, which is made up multiple single metal filaments 11 twisted together or multiple strands of twisted metal filaments 11 twisted together. The metal filaments 11 can be copper (or copper alloy) filaments, tin-plated copper (or copper alloy) filaments, or aluminum (or aluminum alloy) filaments, or any combination thereof. An insulation layer 2, which is formed of a plastic material, such as polyvinyl chloride (PVC), polyethylene (PE), and polypropylene (PP), surrounds, encloses, and houses the conductive line 1 in such a way that the conductive line 1 is located at a center of the insulation layer 2 (which is an axial center of a cross-section of the insulation layer). One or more reinforcement lines 3 are embedded in the insulation layer 2. The reinforcement lines 3 are each made of multiple nylon filaments 31 twisted together and are spaced from and not in contact with the conductive line 1 with portions of the insulation layer 2 located and thus interposed between the conductive line 1 and the reinforcement lines 3. The entire structure of the decoration light cable with improved tensile strength according to the present invention is descried above.

As shown in FIGS. 1 and 2, preferably, three or more reinforcement lines 3 are included in the decoration light cable such that the reinforcement lines 3 are embedded in the insulation layer 2 in a manner of being arranged along a circle and spaced from each other by a constant circumferential interval therebetween to provide the decoration light cable 10 with uniform tensile strength. Further, the nylon filaments 31 that are twisted to form the reinforcement lines 3 can be fine yarns of nylon or alternatively, the nylon filaments 31 can be replaced by other filaments made up of twisted fine yarns of other materials, such as cotton yarns.

As shown in FIGS. 1 and 2, in an embodiment of the present invention, the conductive line 1 that is composed of multiple twisted metal filaments may comprise a first layer 12 and a second layer 13 (which will be respectively referred to as “first conductive line layer” and “second conductive line layer”). The first conductive line layer 12 and the second conductive line layer 13 are each composed of multiple metal filaments 11 twisted together (or multiple twisted strands each of which comprises multiple metal filaments twisted together) and the first conductive line layer 12 is set as a central portion of the conductive line 1 and circumferentially surrounded and enclosed by the second conductive line layer 13 that is a circumferential portion set along a circumferential surface of the central portion.

Referring to FIG. 3, the decoration light cable 10 with improved tensile strength of the present invention has various applications and is applicable, in an example, to decoration lights 20 (such as Christmas lights) or an assembly of such decoration lights, such that the decoration light cable 10 of the present invention serves as an electrical connection line among the decoration lights 20. The above-described improvement involving the reinforcement lines 3 helps increase the tensile strength of the decoration light cable 10 and with the reinforcement lines 3 being embedded in the insulation layer 2, during a process of trimming the insulation layer 2 to expose the conductive line 1, the reinforcement lines 3 that are embedded in the insulation layer, can be surely cut off at the same time and thus the reinforcement lines 3, which can be made of nylon or other material, will not cause any interference with a heating and soldering or welding operation and as such, convenience of soldering or welding and quality of soldiering or welding can be both enhanced.

Illustrated above are the embodiments of the present disclosure, which should not be considered limitative to the scope of the invention. Therefore, any equivalent substitutions or variations to the structures or processes disclosed in the specification and the drawing of the present disclosure, or a direct or indirect application of the invention to the other technical fields should be considered as part of the present disclosure.

What is claimed is:

1. A decoration light cable, comprising:
a conductive line, which comprises a plurality of metal filaments twisted together;
an insulation layer, which surrounds, encloses, and houses the conductive line, such that the conductive line is located at a center of the insulation layer;
and
one or more reinforcement lines, which are embedded in the insulation layer such that the reinforcement lines are spaced and separated from and thus not in contact with the conductive lines by portions of the insulation layer located and interposed between the conductive line and the reinforcement lines.

2. The decoration light cable as claimed in claim 1, wherein three reinforcement lines are embedded in the insulation layer.

3. The decoration light cable as claimed in claim 1, wherein the reinforcement lines each comprise a plurality of nylon filaments twisted together.

4. The decoration light cable as claimed in claim 2, wherein the reinforcement lines each comprise a plurality of nylon filaments twisted together.

5. The decoration light cable as claimed in claim 1, wherein the conductive line comprises a first conductive line layer and a second conductive line layer such that the first conductive line layer is set at a central portion circumferentially enclosed by the second conductive line layer that is set along a circumferential portion.

6. The decoration light cable as claimed in claim 1, wherein the metal filaments are each one of a copper filament, a tin-plated copper filament, and an aluminum filament.

7. The decoration light cable as claimed in claim 5, wherein the metal filaments are each one of a copper filament, a tin-plated copper filament, and an aluminum filament.

8. The decoration light cable as claimed in claim 1, wherein the insulation layer is formed of a plastic material comprising one of polyvinyl chloride (PVC), polyethylene (PE), and polypropylene (PP).
